(19) United States
(12) Patent Application Publication
(10) Pub. No.: US 2024/0263259 A1
(43) Pub. Date: Aug. 8, 2024

(54) Operating method of a network of plants

(71) Applicant: ArcelorMittal, Luxembourg (LU)

(72) Inventors: George TSVIK, Valparaiso, IN (US); Dmitri BOULANOV, East Chicago, IN (US); Jon REYES RODRIGUEZ, AVILES Asturias (ES); Odile CARRIER, Metz (FR); Sarah SALAME, Maizieres les Metz (FR); José BARROS LORENZO, Maizieres les Metz (FR); Marcelo ANDRADE, East Chicago, IN (US); Dennis LU, East Chicago, IN (US)

(21) Appl. No.: 18/559,901

(22) PCT Filed: May 26, 2021
(86) PCT No.: PCT/IB2021/054581

§ 371 Date: Nov. 9, 2023

(51) Int. Cl. C21B 7/00; C21B 13/00

(52) U.S. Cl. CPC C21B 7/002; C21B 13/0073; C21B 2100/22; C21B 2100/26; C21B 2100/80

(57) ABSTRACT

A method of operating a network of plants comprising a blast furnace, a direct reduction furnace, a CO2 conversion unit wherein blast furnace top gas is subjected to a CO2 conversion step to produce a liquid carbon product which is injected into the direct reduction furnace.

The invention is related to a method to operate a network of plants and to the associated network of plants.

### BACKGROUND

Steel can be currently produced through two mains manufacturing routes. Nowadays, the most commonly used production route consists in producing pig iron in a blast furnace, by use of a reducing agent, mainly coke, to reduce iron oxides. In this method, approx. 450 to 600 kg of coke is consumed per metric ton of pig iron; this method, both in the production of coke from coal in a coking plant and in the production of the pig iron, releases significant quantities of CO₂.

The second main route involves so-called “direct reduction methods”. Among them are methods according to the brands MIDREX, FINMET, ENERGIRON/HYL, COREX, FINEX etc., in which sponge iron is produced in the form of HDRI (hot direct reduced iron), CDRI (cold direct reduced iron), or HBI (hot briquetted iron) from the direct reduction of iron oxide carriers. Sponge iron in the form of HDRI, CDRI, and HBI usually undergo further processing in electric arc furnaces.

There are three zones in each direct reduction shaft with cold DRI discharge: Reduction zone at top, transition zone at the middle, cooling zone at the cone shape bottom. In hot discharge DRI, this bottom part is used mainly for product homogenization before discharge, and control of overall solids follow.

Reduction of the iron oxides occurs in the upper section of the furnace, at temperatures up to 950° C. Iron oxide ores and pellets containing around 30% by weight of Oxygen are charged to the top of a direct reduction shaft and are allowed to descend, by gravity, through a reducing gas. This reducing gas is entering the furnace from the bottom of reduction zone and flows counter-current from the charged oxidized iron. Oxygen contained in ores and pellets is removed in stepwise reduction of iron oxides in counter-current reaction between gases and oxide. Oxidant content of gas is increasing while gas is moving to the top of the furnace.

The reducing gas generally comprises hydrogen and carbon monoxide (syngas) and is obtained by the catalytic reforming of natural gas. For example, in the so-called MIDREX method, first methane is transformed in a reformer according to the following reaction to produce the syngas or reduction gas:

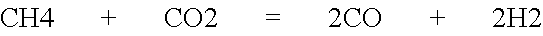

and the iron oxide reacts with the reduction gas, for example according to the following reactions:

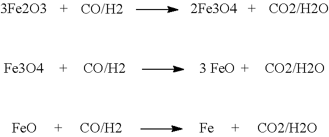

At the end of the reduction zone the ore is metallized.

A transition section is found below the reduction section; this section is of sufficient length to separate the reduction section from the cooling section, allowing an independent control of both sections. In this section carburization of the metallized product happens. Carburization is the process of increasing the carbon content of the metallized product inside the reduction furnace through following reactions:

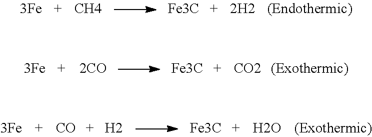

Injection of natural gas in the transition zone is using sensible heat of the metallized product in the transition zone to promote hydrocarbon cracking and carbon deposition. Due to relatively low concentration of oxidants, transition zone natural gas is more likely to crack to H₂ and Carbon than reforming to H₂ and CO. Hydrocarbon cracking provides carbon for DRI carburization and, at the same time adds reductant (H₂) to the gas that increases the gas reducing potential.

Reducing CO2 emissions to meet climate targets is challenging as the currently dominating form of steelmaking, the blast furnace-basic oxygen furnace (BF-BOF) route is dependent on coal as a reductant and fuel. There are two options for reducing CO2 emissions from steelmaking: to keep the BF-BOF route and implement carbon capture and storage of CO2 (CCS) technology, or to seek new low-emissions processes.

A first step towards CO2 emissions reductions maybe then to switch from a BF-BOF route to a DRI route. As this represents big changes, both in terms of equipment, but also in terms of process, all blast furnaces will not be replaced at once by direct reduction equipment. There would thus be some plants where the different equipment will coexist.

There is thus a need for a method allowing to operate a combination of a BF-BOF and DRI routes with the best efficiency, in terms of emission reduction but also energy efficiency and productivity.

The present invention provides a method allowing to operate a network of plants comprising a blast furnace producing hot metal and a blast furnace top gas, a direct reduction furnace wherein oxidized iron is charged to be reduced by a reducing gas to produce direct reduced iron, this reduction furnace comprising a reduction zone, a transition zone and a cooling zone, a CO2 conversion unit wherein the blast furnace top gas is subjected to a CO2 conversion step to produce a liquid carbon product, this liquid carbon product being injected into the direct reduction furnace.

The method of the invention may also comprise the following optional characteristics considered separately or according to all possible technical combinations:
the liquid carbon product is injected at least into the transition zone of the direct reduction furnace,
the liquid carbon product is injected at least into the cooling zone of the direct reduction furnace,
the liquid carbon product is injected in the transition zone and in the cooling zone of the direct reduction furnace,
the liquid carbon product is a biofuel,
the liquid carbon product is liquid alcohol,
the liquid carbon product is liquid hydrocarbon,
the reducing gas comprises more than 50% in volume of hydrogen,
the reducing gas comprises more than 99% in volume of hydrogen,
the network of plants further comprises a coke oven producing coke and a coke oven gas, said coke oven gas being mixed with blast furnace gas to produce the liquid carbon product,
the network of plants further comprises a steelmaking plant producing liquid steel and a steelmaking gas, said steelmaking gas being mixed with blast furnace gas to produce the liquid carbon product,
the CO2 conversion step comprises a biological transformation step.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 illustrates a network of plant to which a method according to the invention may be applied

Elements in the figures are illustration and may not have been drawn to scale.

FIG. 1 illustrates a network of plants to which a method according to the invention may be applied. This network of plants comprises a direct reduction— or shaft— furnace 1 and a blast furnace 2 and a CO2 conversion unit 6. It may also optionally comprise a coke plant 4, a steelmaking plant 3, such as a basic oxygen furnace, and a plant 9 to produce hydrogen, such as an electrolysis plant.

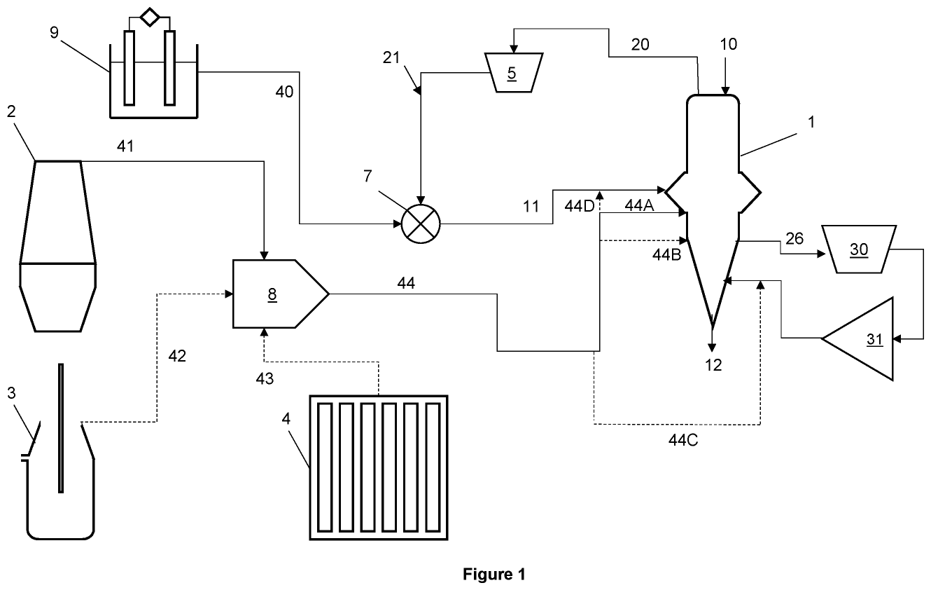

The direct reduction furnace 1 is charged at its top with oxidized iron 10 in form of ore or pellets. Said oxidized iron 10 travels through the shaft by gravity, through a reduction section located in the upper part of the shaft, a transition section located in the midpart of the shaft and a cooling section located at the bottom. It is reduced into the furnace 1 by a reducing gas 11 injected into the furnace and flowing counter-current from oxidized iron. Reduced iron 12 exits the bottom of the furnace 1 for further processing, such as briquetting before being used in subsequent steelmaking steps. Reducing gas 11 after having reduced iron exits at the top of the furnace as a top reduction gas 20 (TRG).

A cooling gas 26 is captured out of the cooling zone, subjected to a cleaning step into a cleaning device 30, such as a scrubber, compressed in a compressor 31 and then sent back to the cooling zone of the shaft 1.

The blast furnace 2 produces hot metal, or pig iron and emits a blast furnace gas (BFG) 41. The basic oxygen furnace 3, or more generally the steelmaking furnace, produce steel out of hot metal and emits a steelmaking gas (BOFG) 42. The coke oven plant 4 produces coke from coal and emits a coke oven gas (COG) 43.

Average composition of the different gases is summarized in table 1—compositions being expressed in % v:

TABLE 1

| | CO | CO2 | H2 | H2O | CH4 | N2 |
|---|---|---|---|---|---|---|
| TRG | 15-25 | 12-20 | 35-55 | 15-25 | 3-8 | 1-4 |
| BFG | 19-27 | 15-25 | 1-8 | — | — | 45-60 |
| BOFG | 55-65 | 14-16 | 3-5 | — | 0-1 | 14-16 |
| COG | 3-6 | 1-5 | 36-62 | — | 16-27 | 1-6 |

The hydrogen production plant 9 produces a flux of hydrogen 40. It may be a water or steam electrolysis plant. It is preferably operated using CO₂ neutral electricity which includes notably electricity from renewable source which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO₂ to be produced.

In the method according to the invention, the blast furnace gas 41, optionally mixed with steelmaking gas 42 and/or coke oven gas 43 is sent to the CO₂ conversion unit 6 where it is subjected to a CO₂ conversion step to be turned into a liquid carbon product 44.

This liquid carbon product 44 may be an alcohol, such as methanol or ethanol, or a hydrocarbon, such as methane. In a preferred embodiment, the CO₂ conversion step includes a biological transformation step, such as fermentation with bacteria or algae to produce a biofuel. In another embodiment it may include hydrogenation and Fischer-Tropsch reactions.

The CO₂ conversion unit comprises all elements allowing to transform the BFG and or the mixture of BFG/BOFG/COG into a suitable gas for the conversion into the liquid carbon product. These elements will of course vary according to the liquid carbon product and are well known from the man skilled in the art of the respective conversion technology.

Thus produced liquid carbon product 44 is then at least partly injected into the shaft 1. It may be injected together with the reducing gas 11 as illustrated by stream 44D or separately in the reduction zone (not illustrated). It may also be injected in the transition zone, as illustrated by stream 44A and/or in the cooling zone, as illustrated by streams 44B and 44C. It may be injected alone 44B or in combination 44C with the cooling gas 13. All those injection locations may be combined with one another.

Once injected into the shaft, the carbon-bearing liquid 44 is cracked by the heat released by hot DRI, this producing a reducing gas and carburizing the DRI product to increase its carbon content. Moreover, the vaporization enthalpy further contributes to the DRI cooling.

The injection of this liquid is made to increase the carbon content of the Direct Reduced Iron to a range from 0.5 to 3 wt. %, preferably from 1 to 2 wt. % which allows getting a Direct Reduced Iron that can be easily handled and that keeps a good combustion potential for its future use.

In a preferred embodiment, the reducing gas 11 comprises at least 50% v of hydrogen, and more preferentially more than 99% v of H₂. An H₂ stream 40 may be supplied to produce said reducing gas 11 by a dedicated H₂ production plant 9, such as an electrolysis plant. It may be a water or steam electrolysis plant. It is preferably operated using CO₂ neutral electricity which includes notably electricity from renewable source which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO₂ to be produced.

In another embodiment, H₂ stream 40 may be mixed with part of the top reduction gas 20 to form the reducing gas 11. When operated with natural gas the top reduction gas 20 usually comprises from 15 to 25% v of CO, from 12 to 20% v of CO2, from 35 to 55% v of H2, from 15 to 25% v of H2O, from 1 to 4% of N2. It has a temperature from 250 to 500° C. When pure hydrogen is used as reducing gas, the composition of said top reduction gas will be rather composed of 40 to 80% v of H2, 20-50% v of H2O and some possible gas impurities coming from seal system of the shaft or present in the hydrogen stream 40. When the H2 amount in the reducing gas varies and the liquid carbon product 44 is injected, the top gas 20 will have an intermediate composition between the two previously described cases.

All the different embodiments previously described may be combined with one another.

The method according to the invention allows to operate the network of plants with a better efficiency and reduced carbon footprint as CO2 from blast furnace is captured and transformed and product of such transformation is reused within the network of plants, allowing notably to avoid the use of external carbon source to be supplied to the direct reduction shaft.

What is claimed is:

1-12. (canceled)

13. A method of operating a network of plants comprising:
producing hot metal and a blast furnace top gas in a blast furnace;
charging oxidized iron to a direct reduction furnace to be reduced by a reducing gas to produce direct reduced iron, the direct reduction furnace comprising a reduction zone, a transition zone and a cooling zone;
subjecting the blast furnace top gas to a CO2 conversion step in a CO2 conversion unit to produce a liquid carbon product; and
injecting the liquid carbon product into the direct reduction furnace.

14. The method as recited in claim 13 wherein the liquid carbon product is injected at least into the transition zone of the direct reduction furnace.

15. The method as recited in claim 13 wherein the liquid carbon product is injected at least into the cooling zone of the direct reduction furnace.

16. The method as recited in claim 13 wherein the liquid carbon product is injected in the transition zone and in the cooling zone of the direct reduction furnace.

17. The method as recited in claim 13 wherein the liquid carbon product is a biofuel.

18. The method as recited in claim 13 wherein the liquid carbon product is liquid alcohol.

19. The method as recited in claim 13 wherein the liquid carbon product is liquid hydrocarbon.

20. The method as recited in claim 13 wherein the reducing gas comprises more than 50% in volume of hydrogen.

21. The method as recited in claim 13 wherein the reducing gas comprises more than 99% in volume of hydrogen.

22. The method as recited in claim 13 wherein the network of plants further comprises a coke oven producing coke and a coke oven gas, the coke oven gas being mixed with blast furnace gas to be turned into the liquid carbon product.

23. The method as recited in claim 13 further comprising producing liquid steel and a steelmaking gas in a steelmaking plant, the steelmaking gas being mixed with blast furnace gas to be turned into the liquid carbon product.

24. The method as recited in claim 13 wherein the CO2 conversion step comprises a biological transformation step.
